(19) United States
(12) Patent Application Publication
(10) Pub. No.: US 2003/0035713 A1
(43) Pub. Date: Feb. 20, 2003

(54) Moisture-controlled wafer storage container and method of using

(75) Inventors: Tsung-Chieh Tsai, Tainan (TW); Ching-Shan Lu, Tainan (TW); Tom Tseng, Tainan (JP)

Correspondence Address: TUNG & ASSOCIATES, 838 W. Long Lake Road, Suite 120, Bloomfield Hills, MI, 48302, US

(73) Assignee: Taiwan Semiconductor Manufacturing Co., Ltd.

(21) Appl. No.: 09/933,503

(22) Filed: Aug. 20, 2001

(51) Int. Cl. B65G 49/07

(52) U.S. Cl. 414/800

(57) ABSTRACT

A moisture-controlled wafer storage container for storing semiconductor wafers during processing and a method for using the container are provided. The container may be constructed of a container body that has a front wall, a back wall, a left-side wall, a right-side wall and a top wall defining a cavity therein for receiving a wafer cassette and wafers stored in the cassette. The cavity is further defined by a bottom wall of a wafer cassette when the cassette is positioned in the container to form a sealed cavity. The container further includes a moisture-absorbing means that is placed in the container or in fluid communication with the sealed cavity of the container for absorbing moisture and for controlling a relative humidity in the sealed cavity to less than 30%, and preferably to less than 20%, and more preferably to less than 10%.

### FIELD OF THE INVENTION

The present invention generally relates to a storage container used in semiconductor fabrication facilities for storing wafers and more particularly, relates to a moisture-controlled wafer storage container that is equipped with a moisture-absorbing device in the container for controlling a relative humidity in the cavity of the container to less than 30%.

### BACKGROUND OF THE INVENTION

In the recent development of semiconductor fabrication technology, the continuous miniaturization in device fabricated demands more stringent requirements in the fabrication environment and contamination control. When the feature size was in the 2 μm range, a cleanliness class of 100-1000 (which means the number of particles at sizes larger than 0.5 μm per cubic foot) was sufficient. However, when the feature size is reduced to 0.25 μm, a cleanliness class of 0.1 is required. It has been recognized that an inert minienvironment may be the only solution to future fabrication technologies when the device size is reduced further. In order to eliminate micro-contamination and to reduce native oxide growth on silicon surfaces, the wafer processing and the loading/unloading procedures of a process tool must be enclosed in an extremely high cleanliness minienvironment that is constantly flushed with ultrapure nitrogen that contains no oxygen and moisture.

Different approaches in modern clean room design have been pursed in recent years with the advent in the ULSI technology. One is the utilization of a tunnel concept in which a corridor separates the process area from the service area in order to achieve a higher level of air cleanliness. Under the concept, the majority of equipment maintenance functions are conducted in low-classified service areas, while the wafers are handled and processed in more costly high-classified process tunnels. For instance, in a process for 16 M and 64 M DRAM products, the requirements of contamination control in a process environment is so stringent that the control of the enclosure of the process environment for each process tool must be considered. This stringent requirement creates a new minienvironment concept which is shown in FIG. 1. Within the enclosure minienvironment of a process tool 10, an extremely high cleanliness class of 0.1 (which means the number of particles at sizes larger than 0.1 μm per cubic foot) is maintained, in contract to a cleanliness class of 1000 for the overall production clean room area 12. In order to maintain the high cleanliness class inside the process tool 10, the loading and unloading sections 14 of the process tool must be handled automatically by an input/output device such as a SMIF (standard mechanical interfaces) apparatus. A cassette of wafers can be transported into the process tool 10 by a SMIF pod 18 situated on top of the SMIF apparatus 20.

In a conventional SMIF apparatus 20 such as that shown in FIG. 1, the apparatus 20 consists of a robotic transfer system (not shown) or a robotic arm which is normally configured for gripping the top of a cassette 30 from a platform on which the cassette 30 placed (inside a pod). The robotic arm, sometimes replaced by a gripper assembly, is capable of transporting the cassette 30 into the process tool and place it onto a platform 16 vertically such that the cassette 30 is oriented horizontally. At the beginning of the process, an operator positions a SMIF pod 18 on top of a platform/elevator 22 which contains a cassette 30 holding, for instance, 24 wafers in an upright position. The elevator then descends into the SMIF apparatus 20 for the robotic arm to transport the cassette 30 into the process tool. The SMIF system 20 is therefore capable of automatically utilizing clean isolation technology to maintain a high class clean room effectiveness near wafers and processing equipment. The operation of the robotic arm or the gripper is controlled by an ancillary computer (not shown) or by the process tool 10. The cassette 30 carries wafers or other substrates that are being processed.

The SMIF apparatus 20 has a port (or opening) 24 which is intimately mated with an opening 26 in the sidewall 28 of the process tool 10. The SMIF pod 18 is a sealed container with an opening at the bottom and therefore is capable of preventing contamination to the cassette held therein. The pod may also be equipped by a tagging system for the automated identification and recognition of the parts contained in the pod to prevent mis-processing of the wafers and to track through the host computer of the product-lot serial numbers. The tagging system is mounted on the pod with a probe assembly mounted on the port of the SMIF apparatus 20. The SMIF apparatus 20 is therefore an effective interface between an operator and the process tool 10 in that the transporting of cassette can be conducted in a completely automated fashion to avoid contact by the operator. This insures that the cassette 30 is transported through a highly clean environment into the process tool 10.

A cross-sectional view of the SMIF pod 18 is shown in FIG. 2. It is seen that the wafer cassette 30 is contained in the pod 18 by inserting the cassette 30 through an open bottom 32 of the pod 18. The cassette 30 is used to store a plurality of wafers 34 inside the wafer cassette 30, a plurality of dividers (not shown) are provided on the two interior sidewalls (not shown) of the cassette body 36 such that wafer receptacles are formed between the dividers. A bottom wall 38 of the wafer cassette 30 also performs the functions as a seal for the bottom opening 32 of the SMIF pod 18.

In the manufacturing process for semiconductor devices, wafers that are contained in a wafer cassette are frequently transported in a SMIF pod 18. The SMIF pod is used not only in transporting wafer cassettes between various processing stations, but also in storing wafers in cassettes waiting to be processed. During such storage, the content of the atmosphere inside the SMIF pod 18 is the same as the clean room atmosphere. The clean room atmosphere contains a regulated amount of moisture, i.e., between about 30% and about 50% relative humidity to avoid excessive static charge build-up and to afford personnel comfort. The same moisture content has adverse effect on wafers stored in the wafer cassette placed in the SMIF pod. The effect is especially severe when the wafers have been deposited, or otherwise formed, with an oxide layer on top of the wafer surface. The moisture readily reacts with the oxide film and causes film stress variations and even corrosion in an underlayer of a metal film. The film stress variations on the surface of a wafer induce other problems in subsequent deposition or forming processes for IC devices.

In more recent semiconductor fabrication technology, copper has been used as the conductive metal in devices of reduced dimensions due to the superior conductivity of copper. It is known that copper can reduce the RC delay in electronic devices and thus, can improve the speed of the devices. However, a serious drawback for using copper in semiconductor fabrication is that copper corrosion occurs when moisture is present in a wafer storage container such as in a SMIF pod or in a FOUP (front opened) pod. When copper corrosion occurs, the adhesion of the copper layer with other layers such as an inter-metal-dielectric (IMD) of oxide is greatly affected leading to a low yield of the fabrication process. The elimination, or at least the reduction, of moisture in a wafer storage container has therefore become an important task in modern semiconductor fabrication development.

The moisture absorption problem incurred in the conventional SMIF pod has lead IC process engineers to propose various solutions. For instance, in some processes the queue time is set as short as possible such that the exposure time of wafer to moisture is minimized. However, depending on the process sequence, a preset short queue time between processes is not always possible. Another solution to the moisture absorption problem incurred in SMIF pods was proposed in which the SMIF pod is placed in a nitrogen box such that the pod is isolated from the clean room air. Even though this may be effective, the installation of a large number of nitrogen boxes which are connected to a nitrogen gas supply is difficult and cumbersome to carry out in an IC fabrication facility.

It is therefore an object of the present invention to provide an apparatus and a method for storing wafers that do not have the drawbacks or shortcomings of the conventional wafer storage apparatus and method.

It is another object of the present invention to provide a wafer storage container wherein wafers may be stored without moisture absorption problem.

It is a further object of the present invention to provide a wafer storage container without the moisture absorption problem by utilizing a desiccant in the container.

It is another further object of the present invention to provide a wafer storage container wherein the relative humidity in the container can be controlled to less than 20%.

It is still another object of the present invention to provide a moisture-controlled wafer storage container by mounting a ventilated container filled with silica gel in the wafer container.

It is yet another object of the present invention to provide a moisture-controlled wafer storage container by mounting a desiccant held in a membrane that is permeable to water molecules but not permeable to solid particles in the wafer container.

It is still another further object of the present invention to provide a method for controlling the moisture level in a wafer storage container such that a relative humidity in the cavity of the container can be controlled to less than 30%.

### SUMMARY OF THE INVENTION

In accordance with the present invention, a moisture-controlled wafer storage container and a method for using the container are disclosed.

In a preferred embodiment, a moisture-controlled wafer storage container is provided which includes a container body that has a front wall, a back wall, a left-side wall, a right-side wall and a top wall defining a cavity therein for receiving a wafer cassette. The cavity is further defined by a bottom wall of a wafer cassette when the cassette is positioned in the container forming a sealed cavity therein; and a moisture-absorbing means in fluid communication with the sealed cavity for absorbing moisture and for controlling a relative humidity in the sealed cavity to less than 30%.

In the moisture-controlled wafer storage container, the relative humidity in the sealed cavity is preferably controlled to less than 20%, and more preferably controlled to less than 10%. The moisture-absorbing means may be a desiccant, or a desiccant held in a membrane permeable to water molecules but not permeable to solid particles, or a ventilated container that is filled with silica gel. The moisture-absorbing means may be positioned in the sealed cavity, or outside the sealed cavity but in fluid communication with the cavity. The container body has a dimension that is sufficiently large for holding 200 mm wafers, or for holding 300 mm wafers.

The present invention is further directed to a standard mechanical interface (SMIF) pod for holding a wafer cassette in a controlled-humidity environment that includes a cover equipped with a handle on top; an inner liner for fitting inside the cover and for sealingly engaging a base; a base that has a hollow center; a gasket for sealing between the inner liner and the base; a lower liner and a door for sealingly engaging the base when the pod is empty and for defining a cavity therein; and at least one moisture-absorbing means positions inside the inner liner for controlling a relative humidity in the cavity to not higher than 30%.

The standard mechanical interface pod may further include a wafer cassette therein, wherein a base plate of the wafer cassette sealingly engages the base of the pod. The at least one moisture-absorbing means is positioned juxtaposed to a wafer cassette installed in the cavity. The at least one moisture-absorbing means may be a desiccant or a desiccant held in a membrane that is permeable to water molecules but not permeable to solid particles. The at least one moisture-absorbing means may be a ventilated container that is filled with silica gel.

The present invention is further directed to a method for controlling the moisture level in a wafer storage container that includes the steps of providing a wafer storage container that has a cavity therein, the cavity is substantially sealed from a surrounding environment outside the container; positioning a wafer cassette filled with wafers inside the cavity; and mounting at least one moisture-absorbing means inside the cavity for controlling a relative humidity in the cavity to not higher than 30%.

The method for controlling the moisture level in a wafer storage container may further include the step of providing the at least one moisture-absorbing means in a desiccant, or the step of providing the at least one moisture-absorbing means in a desiccant held in a membrane that is permeable to water molecules only, or the step of providing the at least one moisture-absorbing means in a ventilated container filled with silica gel. The method may further include a step for controlling a relative humidity in the cavity to not higher than 10%.

### BRIEF DESCRIPTION OF THE DRAWINGS

These and other objects, features and advantages of the present invention will become apparent from the following detailed description and the appended drawings in which:

FIG. 1 is an illustration of a cross-section of a conventional semiconductor process tool that has a wafer storage container positioned thereon.

FIG. 2 is an illustration of a cross-sectional view of a SMIF pod holding a wafer cassette therein.

FIG. 3 is an exploded view of the components of the present invention wafer storage container equipped with moisture-absorbing means.

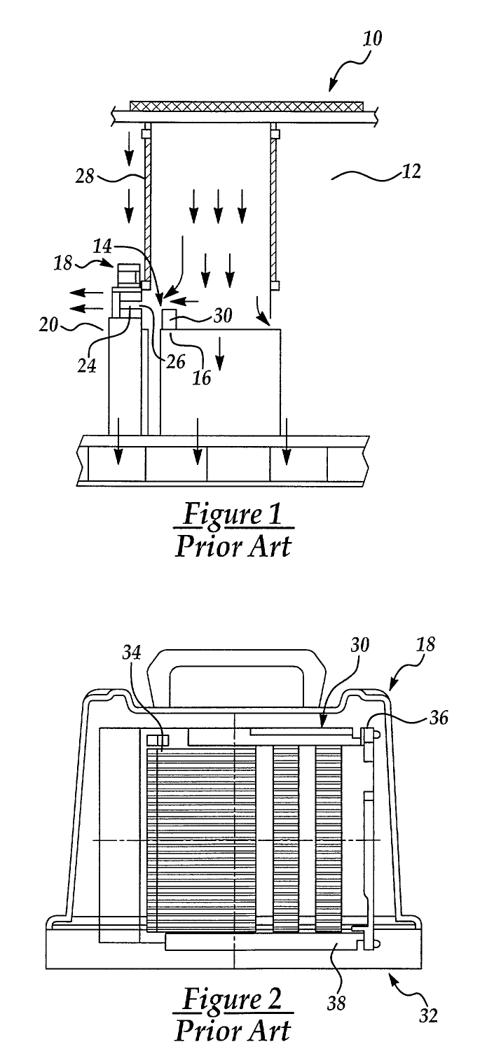

### DETAILED DESCRIPTION OF THE PREFERRED EMBODIMENT

The present invention discloses a moisture-controlled wafer storage container that is used for holding a wafer cassette and wafers stored therein. The moisture-controlled wafer storage container of the present invention effectively controls the moisture level inside the container to a relative humidity of less than 30%, preferably less than 20%, and more preferably to less than 10%. While the present invention moisture-controlled wafer storage container can be used for storing any type of semiconductor wafers, it is particularly suited for storing wafers that have copper layers deposited thereon and thus, are susceptible to copper corrosion and resulting damages to the device structure fabricated.

The present invention moisture-controlled wafer storage container can be constructed with a container body that has a front wall, a back wall, a left-side wall, a right-side wall and a top wall defining a cavity therein for receiving a wafer cassette. The cavity is further defined by a bottom wall of a wafer cassette when the cassette is positioned in the container to form a sealed cavity therein. The container further includes a moisture-absorbing means in fluid communication with the sealed cavity, or positioned inside the sealed cavity, for absorbing moisture and for controlling a relative humidity in the sealed cavity to less than 30%.

The moisture-absorbing means utilized in the present invention moisture-controlled wafer storage container may be a desiccant, or a desiccant contained in a membrane that is permeable to water molecules but not to solid particles, or a ventilated container that is filled with silica gel.

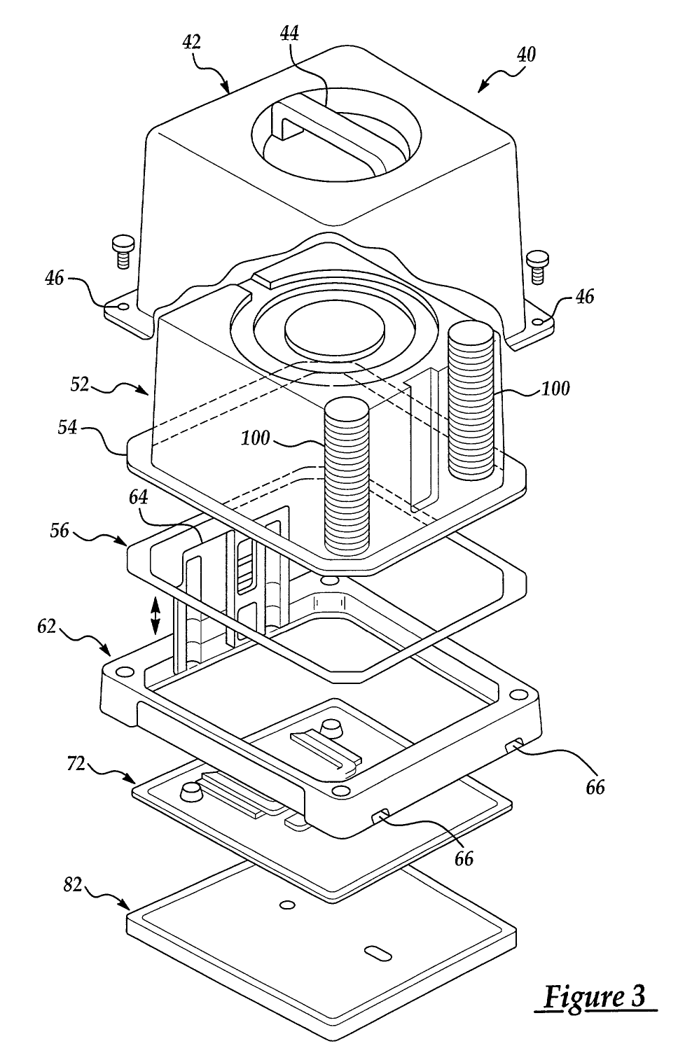

Referring now to FIG. 3, wherein an exploded view of the components of the present invention moisture-controlled wafer storage container 40 is shown. The moisture-controlled wafer storage container 40 is constructed of a top 42 equipped with a handle 44 thereon, and a mounting means or screw holes 46 for mechanical fastening to a base 62. The top 42 is equipped with an upper liner 52 that fits inside the top 42 for providing further insulation. The upper liner 52 is further equipped with a flange portion 54 that provides a seal against a gasket member 56 and the base 62. The gasket 56 may be suitably formed of an elastomeric material that has sufficient elasticity and resiliency. On the base member 62, a wafer lock 64 is further provided, together with latch mechanisms 66 for latching onto either a lower liner piece 72 and/or a bottom door 82. It should be noted that the lower liner 72 and the door 82 are not required when the wafer storage container 40 is loaded with a wafer cassette (not shown) therein. The bottom plate of the wafer cassette would serve as the bottom door for the wafer container 40.

Inside the upper liner 52, is provided at least one moisture-absorbing means 100 which may be a desiccant, a desiccant contained in a membrane that is permeable to water molecules but not to solid particles to prevent particle contamination of the container interior, or a ventilated container that is filled with a silica gel. The desiccant may be suitably chosen such that its color changes after absorbing moisture. This provides an indication for a need for replacement when the desiccant is consumed by moisture. The desiccant can be recycled by drying for reuse. One of the suitable desiccants is silica gel which is normally supplied in a granular form, i.e., a colloidal silica that resembles course white sand in appearance but possessing a large number of fine pores and therefore, is extremely absorbent to water molecules. Any other suitable desiccant may also be used for absorbing the moisture and for providing moisture control in the wafer storage container. It should be noted that the desiccant is a consumable item that should be replenished, or replaced, or recycled after a pre-determined time of usage.

Since the clean room atmosphere is normally controlled to a moisture level between about 30% and about 50% relative humidity to avoid static charge build-up and to provide personnel comfort, the present invention moisture-controlled wafer storage container controls the moisture level to below 30% relative humidity, preferably below 20% relative humidity, and more preferably below 10% relative humidity in order to prevent corrosion of metal layers, i.e., such as copper layers deposited on the semiconductor wafer.

The present invention moisture-controlled wafer storage container and a method for using the container have therefor been amply described in the above descriptions and in the appended drawing of FIG. 3.

While the present invention has been described in an illustrative manner, it should be understood that the terminology used is intended to be in a nature of words of description rather than of limitation.

Furthermore, while the present invention has been described in terms of a preferred embodiment, it is to be appreciated that those skilled in the art will readily apply these teachings to other possible variations of the inventions.

The embodiment of the invention in which an exclusive property or privilege is claimed are defined as follows.

What is claimed is:

1. A moisture-controlled wafer storage container comprising:
a container body having a front wall, a back wall, a left-side wall, a right-side wall and a top wall defining a cavity therein for receiving a wafer cassette, said cavity being further defined by a bottom wall of a wafer cassette when said cassette is positioned in the container forming a sealed cavity therein; and
a moisture-absorbing means in fluid communication with said sealed cavity for absorbing moisture and for controlling a relative humidity in said sealed cavity to less than 30%.

2. A moisture-controlled wafer storage container according to claim 1, wherein said relative humidity in said sealed cavity is preferably controlled to less than 20%.

3. A moisture-controlled wafer storage container according to claim 1, wherein said relative humidity in said sealed cavity is more preferably controlled to less than 10%.

4. A moisture-controlled wafer storage container according to claim 1, wherein said moisture-absorbing means is a desiccant.

5. A moisture-controlled wafer storage container according to claim 1, wherein said moisture-absorbing means is a desiccant held in a membrane that is permeable to water molecules but not permeable to solid particles.

6. A moisture-controlled wafer storage container according to claim 1, wherein said moisture-absorbing means is a ventilated container filled with silica gel.

7. A moisture-controlled wafer storage container according to claim 1, wherein said moisture absorbing means is positioned in said sealed cavity.

8. A moisture-controlled wafer storage container according to claim 1, wherein said container body has a dimension sufficiently large for holding 200 mm wafers.

9. A moisture-controlled wafer storage container according to claim 1, wherein said container body has a dimension sufficiently large for holding 300 mm wafers.

10. A standard mechanical interface (SMIF) pod for holding a wafer cassette in a controlled-humidity environment comprising.
a cover equipped with a handle on top;
an inner liner for fitting inside said cover and for sealingly engaging a base;
a gasket for sealing between said inner liner and said base;
a lower liner and a door for sealingly engaging said base when said pod is empty and for defining a cavity therein; and
at least one moisture-absorbing means positioned inside said inner liner for controlling a relative humidity in said cavity to not higher than 30%.

11. A standard mechanical interface (SMIF) pod for holding a wafer cassette in a controlled-humidity environment according to claim 10 further comprising a wafer cassette therein wherein a base plate of said wafer cassette sealingly engages said base of the pod.

12. A standard mechanical interface (SMIF) pod for holding a wafer cassette in a controlled-humidity environment according to claim 10, wherein said at least one moisture-absorbing means is positioned juxtaposed to a wafer cassette installed in said cavity.

13. A standard mechanical interface (SMIF) pod for holding a wafer cassette in a controlled-humidity environment according to claim 10, wherein said at least one moisture-absorbing means is a desiccant.

14. A standard mechanical interface (SMIF) pod for holding a wafer cassette in a controlled-humidity environment according to claim 10, wherein said at least one moisture-absorbing means is a desiccant held in a membrane that is permeable to water molecules but not permeable to solid particles.

15. A standard mechanical interface (SMIF) pod for holding a wafer cassette in a controlled-humidity environment according to claim 10, wherein said at lest one moisture-absorbing means is a ventilated container filled with silica gel.

16. A method for controlling the moisture level in a wafer storage container comprising the steps of:
providing a wafer storage container having a cavity therein, said cavity being substantially sealed from a surrounding environment outside the container;
positioning a wafer cassette filled with wafers inside said cavity; and
mounting at least one moisture-absorbing means inside said cavity for controlling a relative humidity in said cavity to not higher than 30%.

17. A method for controlling the moisture level in a wafer storage container according to claim 16, further comprising the step of providing said at least one moisture-absorbing means in a desiccant.

18. A method for controlling the moisture level in a wafer storage container according to claim 16, further comprising the step of providing said at least one moisture-absorbing means in a desiccant held in a membrane that is permeable to water molecules.

19. A method for controlling the moisture level in a wafer storage container according to claim 16, further comprising the step of providing said at least one moisture-absorbing means in a ventilated container filled with silica gel.

20. A method for controlling the moisture level in a wafer storage container according to claim 16, further comprising the step of controlling a relative humidity in said cavity to not higher than 10%.
